(19) United States
(12) Patent Application Publication
(10) Pub. No.: US 2011/0258933 A1
(43) Pub. Date: Oct. 27, 2011

(54) MECHANIZED DOOR DRIVE LINKAGE ASSEMBLY

(76) Inventor: Mark J. Quintile, Brunswick, OH (US)

(21) Appl. No.: 12/912,010

(22) Filed: Oct. 26, 2010

Related U.S. Application Data
(60) Provisional application No. 61/254,832, filed on Oct. 26, 2009.

(51) Int. Cl. E05F 11/54

(52) U.S. Cl. 49/358

(57) ABSTRACT

A mechanized door drive linkage assembly for connection to a track mounted door for mechanized translation of the door along the tracks between a closed position and an open position, a generally linear arm attached at a first end to a movable car bracket mounted upon a rail, the arm extending generally downward from the car bracket and proximate to an upper region of a door when the door is in a closed position, the arm having a linear length and a generally planar central section and one or more flanges which extend from edges of the central section and which extend out of a plane Of the central section and away from a second side of the arm which is defined by the central section, the one or more flanges terminating generally perpendicular to the central section, the one or more flanges extending substantially along a length of the arm, and a plurality of openings in the central section configured for the passage of one-or more fasteners through the central section; an elbow bracket having a first segment and a second segment and an elbow segment which connects the first segment with the second segment, the first or second segment generally aligned with and attached to the arm substantially flush against the second side of the central section of the arm and generally opposite the one or more flanges, and a distal end of the segment of the elbow bracket which is not attached to the arm extending laterally of the arm for connection to a bracket mounted to a door.

### RELATED APPLICATIONS

This application is a conversion of U.S. provisional patent application No. 61/254,832, filed Oct. 26, 2009.

### FIELD OF THE INVENTION

The present invention is in the general field of mechanized lifting assemblies for use in connection with doors or automated doors.

### BACKGROUND OF THE INVENTION

In conventional mechanized door systems, such as for opening and closing overhead or other track-mounted doors, there is typically provided a drive system which propels the door or panels thereof along the tracks to perform the opening or closing motion. The drive system has a motive force generator such as an electric motor which drives a conveyor bracket or car along a track motion path for opening or closing. The conveyor or track-mounted car is mechanically coupled to the door or to at least one panel of the door. The coupling can in some installations be reduced to a single arm or member which extends from the conveyor, such as a chain or belt drive, to the door. The drive system components must have adequate strength to translate the driving force to the door and repeatedly move the mass of the door.

In prior art systems, the member which connects the drive system to the door is made in the form of a solid steel bar or link bar. One end of the bar is received in a clevis attached to the conveyor, and an opposite end attached to a first end of a bracket, typically in the form of a “V” or elbow, the other end of which is attached to a bracket or other structure of a door. The solid steel form of the bar, for example as thick as ¼″ bar stock (1 inch wide or greater), has sufficient strength to transfer the force of the conveyor to the door, most of which is linear, but also has excessive mass which is very costly for mass production of millions of units, including the cost of fabricating (punching, shaping, forming, handling, de-burring) with this type of manufactured steel stock. Also, the combination of the link bar with the L-shaped bracket or elbow is not mechanically optimal or economical because the rigidity and strength (i.e., bending moment) of the link bar can be much greater than that of the bracket, or the bracket may also have excessive mass for the application.

### SUMMARY OF THE PRESENT INVENTION

The present invention provides an improved mechanized door operation drive linkage assembly which has substantial and adequate strength for transfer of motion between a drive system or conveyor and a door, and which substantially reduces the mass and material requirements and cost for these components of a mechanized door assembly.

In accordance with the principles of the invention, a link arm or “arm” member of a mechanized door operation assembly has a two or three part cross-sectional configurations including a central plane or central section and at least one additional leg or flange or two generally opposed legs or flanges projecting in the same direction away from the central section Or diverging from the plane. The relative dimensions of the plane or central section may be 0.25 to 2.00 inches in width and 8 to 24 inches in length or greater, and material thicknesses in an approximate range of 0.059 to 0.25 inch material thickness. The legs or flanges may range in thickness from for example 0.047 to 0.250 inches and have an extent from the plane of the central section in a range of 0.12 to 0.75 inches. The projection of the legs from the plane creates a three-dimensional profile to the link arm which is reduced at the conveyor mechanism attachment end, e.g. for engagement with a clevis or other bracketry of the door operation mechanism. The linear extent of the reduction at this attachment end of the link arm can be in the range of 0.059 to 3.00 inches or greater. The reduction is accomplished by lowering the profiles of one or both of the legs proximate to the central plane.

The link arm is preferably fabricated as a steel part, e.g., stamped from steel stock in a range of thicknesses as noted, or roll-formed into the illustrated configurations. Stamping and roll-forming provides the manufacturing advantages of close tolerances and high quality, high volume and efficient part production and the most cost-effective production methods for the designs of the present disclosure.

In accordance with a representative embodiment of the disclosure and related inventions, there is provided a mechanized door drive linkage assembly for connection to a track mounted door for mechanized translation of the door along the tracks between a closed position and an open position, the mechanized door drive linkage assembly having a generally linear arm attached at a first end to a movable car bracket mounted upon a rail, the arm extending generally downward from the car bracket and proximate to an upper region of a door when the door is in a closed position, the arm having a linear length and a generally planar central section and one or more flanges which extend from edges of the central section and which extend out of a plane of the central section and away from a second side of the arm which is defined by the central section, the one or more flanges terminating generally perpendicular to the central section, the one or more flanges extending substantially along a length of the arm, and a plurality of openings in the central section configured for the passage of one or more fasteners through the central section; an elbow bracket having a first segment and a second segment and an elbow segment which connects the first segment with the second segment, the first or second segment generally aligned with and attached to the arm substantially flush against the second side of the central section of the arm and generally opposite the one or more flanges, and a distal end of the segment of the elbow bracket which is not attached to the arm extending laterally of the arm for connection to a bracket mounted to a door.

### DESCRIPTION OF THE DRAWINGS

In the accompanying drawings:

FIG. 1 illustrates a mechanized door drive linkage assembly of the present disclosure;

FIGS. 2A-2F illustrate various cross-sectional configurations of an arm of the mechanized door drive linkage assembly of the present disclosure;

FIGS. 3A and 3B illustrate one embodiment of an arm and elbow bracket of a mechanized door drive linkage assembly of the present disclosure;

FIGS. 4A and 4B illustrate another embodiment of an arm and elbow bracket of a mechanized door drive linkage assembly of the present disclosure;

FIGS. 5A and 5B illustrate another embodiment of an arm and elbow bracket of a mechanized door drive linkage assembly of the present disclosure, and

FIGS. 6A-6D illustrate various embodiments of an elbow bracket of a mechanized door drive linkage assembly of the present disclosure.

### DETAILED DESCRIPTION OF PREFERRED AND ALTERNATE EMBODIMENTS

The link arm is connected to an elbow bracket which is generally L-shaped, with a first segment or arm which is generally aligned with the link arm, and a second segment which is generally angled relative to the first segment, in a range of for example 1-135 degrees, and with a distal end in the same plane as the first segment. The elbow bracket is preferably positioned against the planar section of the link arm and attached as shown, with the legs of the link arm extending away from the elbow bracket. The length of the first segment may be greater than a length of the second segment, or of equal length. A width of the first segment of the elbow bracket is preferably in the same range or less than a width of the planar section of the link arm, and ends of the elbow bracket may be reduced in width as shown, e.g. to 1.00 inch. Exemplary width ranges are 0.40-2.00 inches. The thickness of the elbow bracket material may be comparable to that of the link arm, or greater or thinner. Exemplary material thicknesses are in an approximate range of 0.050-0.187 of an inch.

The elbow bracket may be reinforced, particularly at the elbow as shown by “dishing” or offset (or double offset or stepped) or gusset or formed ribbed, in any of the illustrated configurations, or any other type of reinforcement, and which preferably maintains the second segment in the same plane as the first segment at the respective distal ends. Also, importantly the dish or offset or gusset is in the direction away from the extension of the legs from the plane of the link arm, so that the dish or offset does not interfere with the connection of the elbow bracket with the link arm, regardless of the adjusted, and fastener-attached position of the elbow bracket relative to the link arm, as shown. The reinforcement dish is preferably located in a middle region of the elbow bracket. In a preferred embodiment, the segment of the elbow bracket which is configured for alignment with the link arm is generally longer than the other segment, and has two or more fastener attachment through-holes, the location of which are different than the fastener attachment through-holes in the other segment. In the arm of the elbow bracket which is aligned with the link arm, at least one of the fastener attachment through-holes in one segment (e.g. the segment which is aligned with the link arm) is located closer to the elbow than the fastener attachment through-holes in the other segment. This provides a stronger mechanical connection of the elbow bracket to the link arm to transfer forces from the door to the link arm.

The invention thus provides an improved mechanized door operation drive linkage with a high strength precision roll-formed link arm and mating stamped elbow bracket which provides optimal mechanical linkage between a door drive system and track mounted door, and which is compatible with existing mechanized door operating systems at a very economical cost. As described, the drive linkage assembly includes a link arm which is three-dimensional, e.g., roll-formed, and which has a reduced end for engagement with a bracket of a drive system, an elbow bracket which is attached to an opposite end of the link arm, the elbow bracket having a reinforcement gusset or offset which projects in a direction away from the leg or legs of the link arm, with ends of the elbow bracket reduced to a width dimension equal to or less than a width dimension of the arm, with an opposite end of the elbow bracket configured to be received by or engaged with an attachment structure of a door.

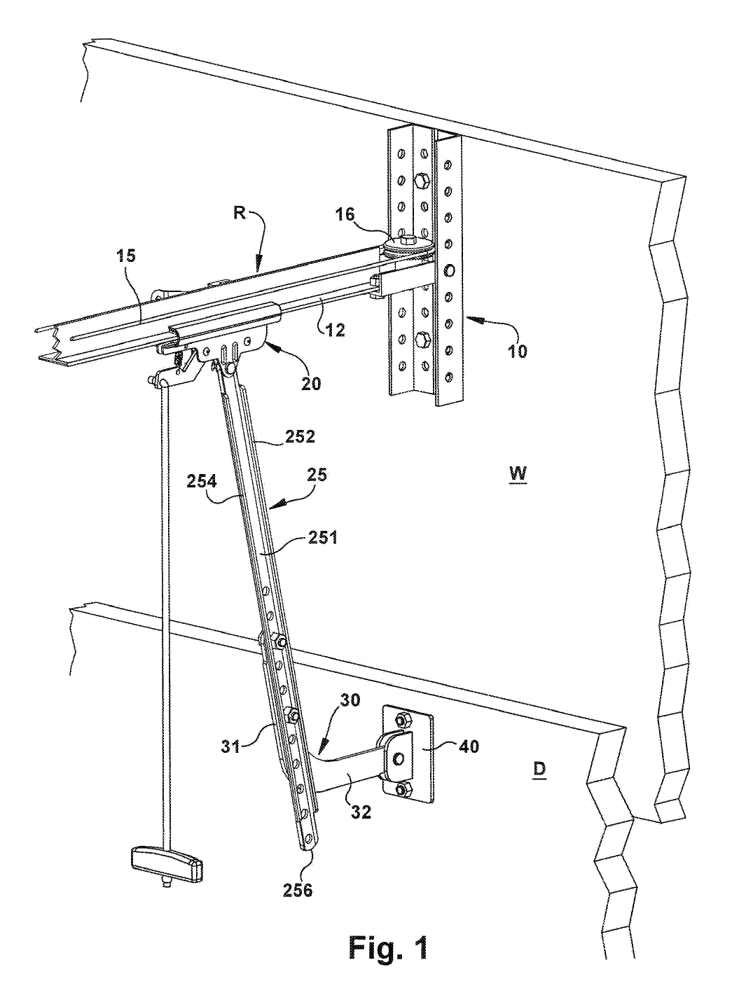

As shown in a representative embodiment in FIG. 1, a door D, such as a track mounted door or overhead door such as for example a garage door, or any movable or foldable panel or partition which is mounted upon tracks or rails (not shown) to travel in a path of the tracks or rails in either direction, i.e., opened or closed, against or in cooperation with an opening in a wall W. For mechanized movement of the door D, it is connected to a conveyance assembly which includes a bracket 10, in this case mounted to wall W, which supports a rail R disposed generally perpendicular to wall W and generally above the door D, and which is also fixedly supported at an opposite end (not shown) so that the rail R is generally horizontally disposed. Slidably engaged with the rail is a car bracket 20 which fits, for example, about one or more flanges 12 of the rail R whereby it is supported by the rail R and is able to move along the length of the rail in the horizontal path. The car bracket 20 is a attached to a drive line, such as for example a cable 15 which is driven by a motor (not shown) in a circuitous path about pulleys 16 proximate to the rail R. Powered movement of the cable 16 along the driveline causes the car bracket 20 to translate along the rail R in the direction of movement of the cable on one side of the rail R.

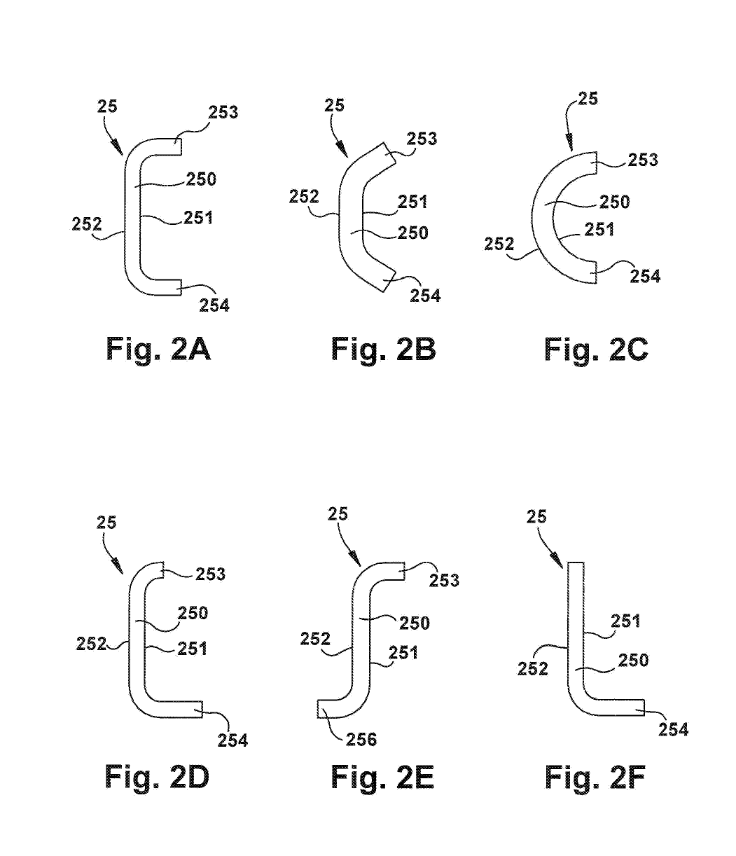

An arm 25 extends generally downward from the car bracket 20 and rail R and generally toward an upper region of the door D, and ultimately for connection to the door D as further described. The arm may be of any length depending upon the application and dimensions of installation, and in this example has a total length of approximately twenty (20) inches, and a total width in this particular embodiment of approximately one (1) inch. In a most preferred form, the arm 25 has a three-dimensional cross-sectional configuration, examples of which arc illustrated in cross-section in FIGS. 2A-2F. As shown therein, the arm 25 can be made, for example as a roll-formed shape or component or a roll-formed section or by any other manufacturing process, such as stamping, to have a central section 250 which in a most preferred form is generally planar or has at least some planar segment, but which may otherwise be curved or partially curved as shown. The arm 25, and the central section 250 of the arm 25 has a first side 251 and a second side 252, and in the embodiments of FIGS. 2A-2E, a first flange 253 and a second flange 254, both of which extend laterally from the central section 250. In the embodiments of FIGS. 2A-2D, the first and second flanges 253, 254 extend laterally from central section 250 in the same direction. In the embodiment of FIG. 2E, the first flange 253 extends from the central section 250 in a first direction and the second flange 254 extends from the central section 250 in a second direction generally opposite the first direction. The configuration of FIG. 2F has only a single flange 254 which extends laterally from the central section 250 and which also provides sufficient rigidity to the arm 25. These three-dimensional cross-sectional configurations of the arm 25 provide sufficient mechanical strength to the arm 25 for the forces encountered in the described operation and movement of mechanized door installations, and allow the arm 25 to be economically manufactured in a stamping and/or roll-forming operation. As a result the present disclosure and related inventions provide a mechanized door solution which is far superior in manufacturing costs and engineering performance to prior art approaches which include the use of machined bar stock.

Preferably the ends of the arm 25 are “necked-down” by being formed without the flanges 253, 254 for ease of attachment to a clevis and/or to the brackets as described. Also the ends of the arm 25 are preferably radiused, at for example in the range of 0.20 to 1.13 inches for ease of attachment and operation. At least one opening is formed in the central region 250 as close to each end of the arm 25 as possible or otherwise proximate to each end.

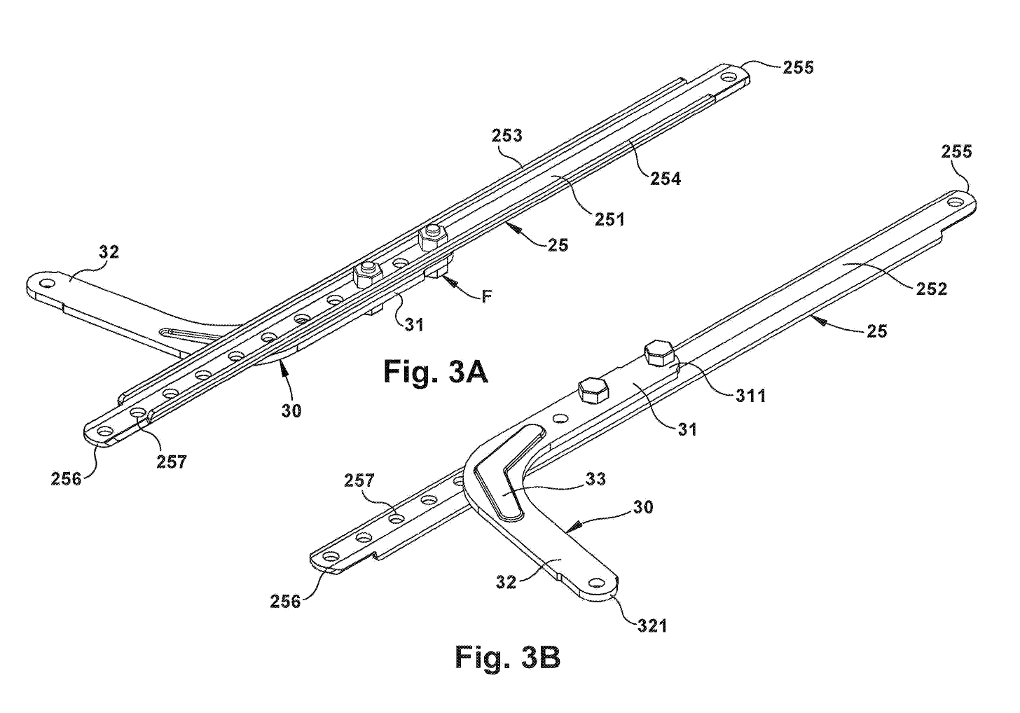

As shown in FIGS. 3A and 3B, ends 255 and 256 of the arm 25 may be configured without the flanges just described, which may facilitate attachment to the car bracket 20 as shown in FIG. 1. One or more holes 257 or other openings may be formed in the arm 25, for example in the central section 250.

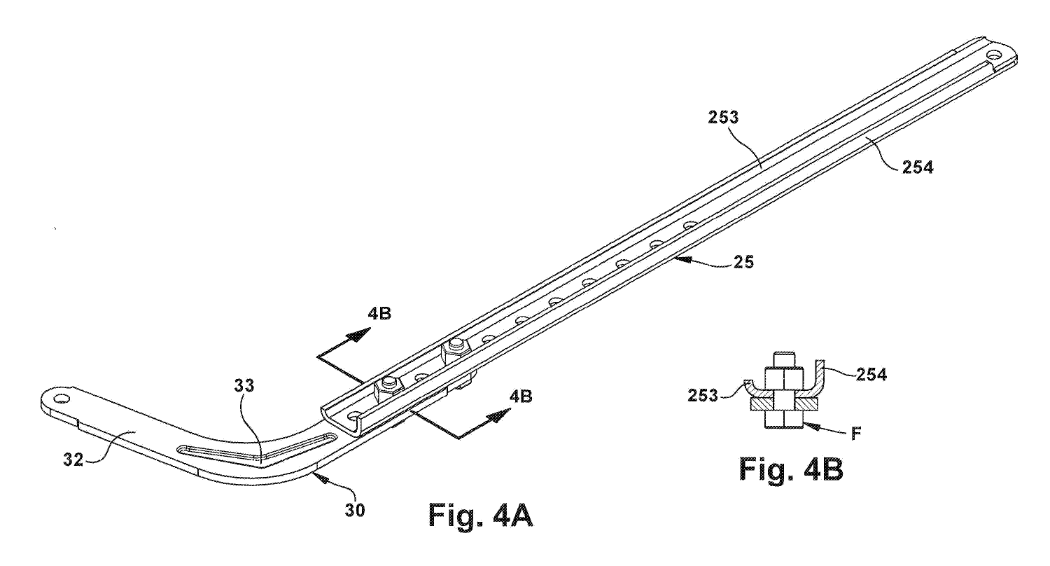

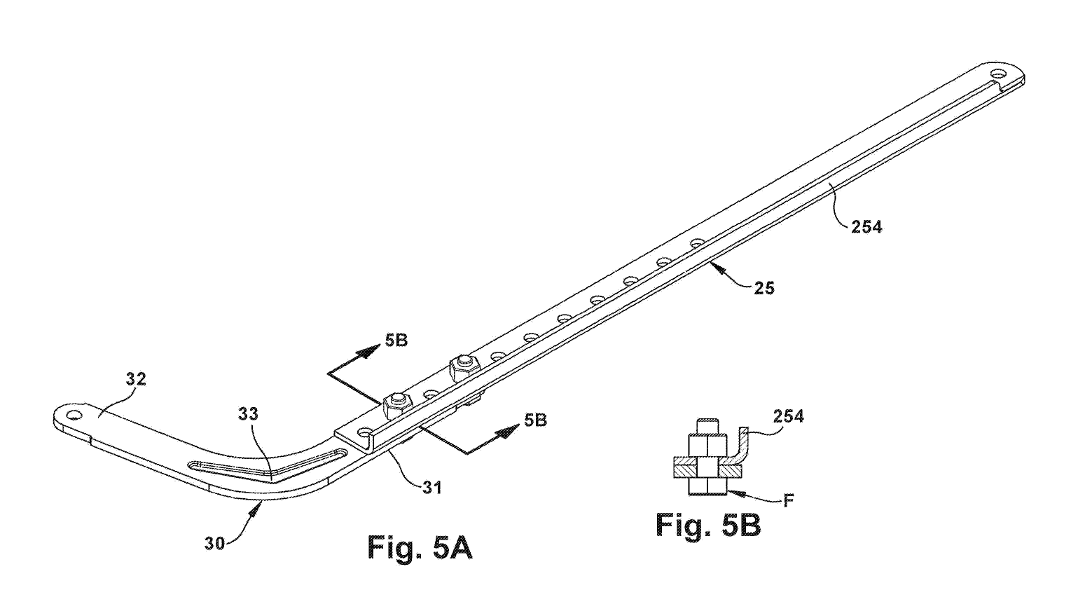

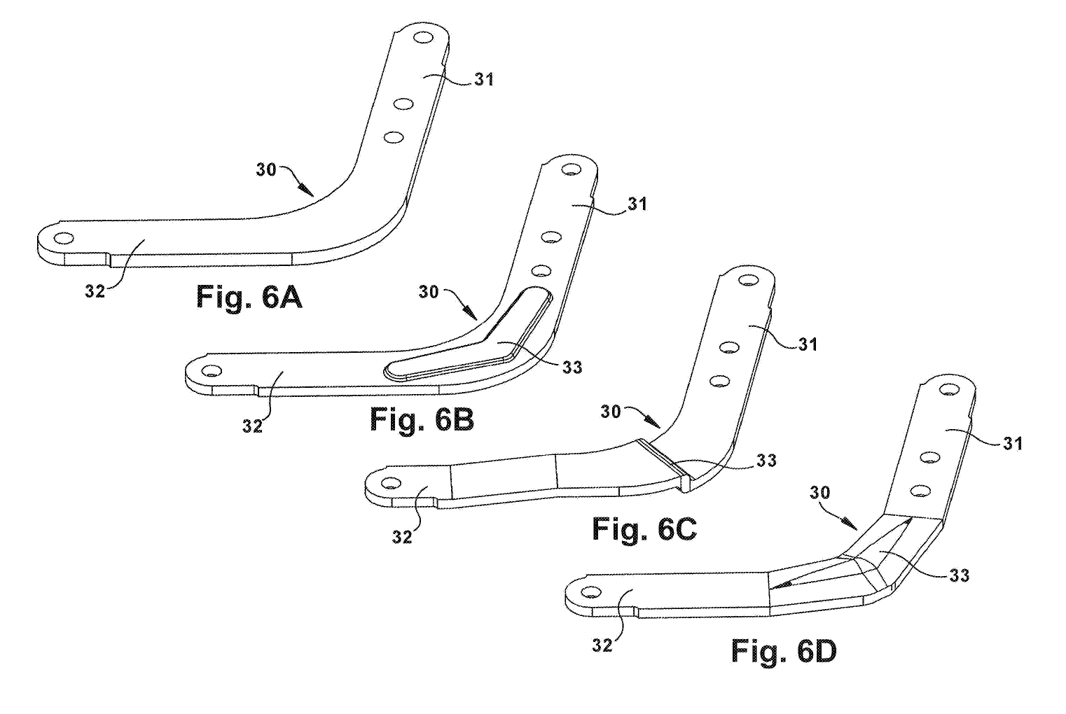

As shown in FIGS. 1, 3A, 3B, 4A, 5A a bracket 30, also referred to herein as “elbow bracket” is fastened to the arm 25 and more specifically to the central section 250, with a first segment 31 generally aligned with the length of the arm 25 and a second segment 32 extending laterally of arm 25. The first segment 31 is connected to the second segment 32 at an elbow which orients the two segments at any desired design angle and generally in the same plane. The first segment 31 is preferably longer than second segment 32 to provide a greater attachment extent along the length of the arm 25. However other configurations of the elbow bracket 30 are possible with different lengths to the segments and different angles between the segments. A stiffening gusset 33 can be formed at or in the region of the elbow of the bracket 30. The gusset 33 may project out from the plane of the elbow bracket 30, in which case the gusset 33 is oriented to project away from the arm 25 and away from surface 252 of the arm, as shown. Other forms of the bracket 30 are shown in FIGS. 6A-6D with various forms of gussets 33, or without a gusset as shown in FIG. 6A.

Most preferably, the elbow bracket 30 is attached to side 252 of the arm 25, by fasteners F, generally opposite to the flanges 253, 254. The elbow bracket 30 can be located at any position along the length of the arm 25 for any particular installation. This is also true with respect to the embodiments of FIGS. 2E and 2F wherein the elbow bracket 30 can be secured to either side 251 or 252 of the arm 25. A preferred installation however is for the elbow bracket 30 to be secured to side 252, i.e., opposite to the extension of the one or more flanges.

End 321 of the second segment 32 of elbow bracket 30 is attached to a door bracket 40, which is fastened to the interior of the door D. As shown, the location of the elbow bracket 30 can be adjusted relative to the arm 25 and door D for any particular installation, along the length of arm 25 and upon surface 252 of the central section 250, and without interference with flanges 253, 254.

The disclosure and related inventions thus provide improved components and assembly for mechanized door drive linkage which has sufficient strength and is adjustable and adaptable to a wide variety of installations.

1. A mechanized door drive linkage assembly for connection to a track mounted door for mechanized translation of the door along the tracks between a closed position and an open position, the mechanized door drive linkage assembly comprising:
a generally linear arm attached at a first end to a movable car bracket mounted upon a rail, the arm extending generally downward from the car bracket and proximate to an upper region of a door when the door is in a closed position, the arm having a along a linear length a generally planar central section and one or more flanges which extend from edges of the central section and which extend out of a plane of the central section and away from a second side of the arm which is defined by the central section, the one or more flanges terminating generally perpendicular to the central section, the one or more flanges extending substantially along a length of the arm, and a plurality of openings in the central section configured for the passage of one or more fasteners through the central section;
an elbow bracket having a first segment and a second segment and an elbow segment which connects the first segment with the second segment, the first or second segment generally aligned with and attached to the arm substantially flush against the second side of the central section of the arm and generally opposite the one or more flanges, and
a distal end of the segment of the elbow bracket which is not attached to the arm extending laterally of the arm for connection to a bracket mounted to a door.

2. The mechanized door drive linkage assembly of claim 1 wherein the first segment of the elbow bracket is located entirely on the second side of the central section and secured to the arm by one or more fasteners which extend through the elbow bracket and the central section of the arm.
